(19) United States
(12) Patent Application Publication
(10) Pub. No.: US 2009/0207187 A1
(43) Pub. Date: Aug. 20, 2009

(54) MOBILE TERMINAL FOR MULTI-DISPLAYABLE CONTENTS INFORMATION WHICH IS COMPOSED WITH INDEPENDENT CHANNEL, METHOD THEREOF, AND COMPUTER READABLE RECORD MEDIUM ON WHICH PROGRAM FOR EXECUTING METHOD IS RECORDED

(75) Inventor: Chang Seok Lee, Seoul (KR)

Correspondence Address: Cozen O''Connor, 250 Park Avenue, New York, NY, 10177, US

(73) Assignee: INTROMOBILE CO., LTD., Seoul (KR)

(21) Appl. No.: 11/816,371

(22) PCT Filed: Feb. 23, 2005
(86) PCT No.: PCT/KR2005/000487

§ 371 Date: Aug. 15, 2007

(30) Foreign Application Priority Data
Feb. 17, 2005 (KR) 10-2005-0013305

(51) Int. Cl. G09G 5/00

(52) U.S. Cl. 345/629

(57) ABSTRACT

A method of a mobile communication terminal displaying channels, and more particularly, to a mobile communication terminal that is capable of multi-displaying contents information that is composed of independent channels are provided. The mobile communication terminal comprises an input unit for a user inputting commands in order to read or check contents information, a communication unit for transmitting contents information on channels to a service server and for receiving the contents information on channels from the service server through a communication network, a display unit for displaying the contents information that is provided from the service server or the contents information that is stored in the mobile communication terminal on a window screen, a storage unit for storing the contents information and contents information screen forming programs that enable the contents information to be composed of independent channels, and a control unit for updating the previously stored contents information to corresponding recent contents information, for forming a requested screen in accordance with the input of a user, and for assigning resources so that the plurality of contents information items are multi-displayed on one display screen.

### TECHNICAL FIELD

The present invention relates to a method of displaying channels in a mobile communication terminal, and more particularly, to a mobile communication terminal that is capable of multi-displaying contents information that is composed of independent channels.

### BACKGROUND ART

The applicant of the present invention filed International Patent Application No. PCT/KR2004/000897 that is entitled “Method and Apparatus for Controlling and Managing Idle Screen Resources for Mobile Communication Terminal”.

FIG. 1 illustrates a mobile communication terminal screen that is implemented in accordance with an embodiment of an idle screen template of the “Method and Apparatus for Controlling and Managing Idle Screen Resources for Mobile Communication Terminal” of the International Patent Application No. PCT/KR2004/000897.

As illustrated in FIG. 1, the idle screen template that is composed of a plurality of channels is displayed on the screen of the mobile communication terminal.

That is, a plurality of channel information items are displayed on the screen of the mobile communication terminal by various templates. However, it is not possible to freely display a plurality of windows on a screen unlike in a common personal computer and to scroll, pan, and move a screen.

Also, it is not possible to effectively use channel resources that are not used.

### DISCLOSURE OF INVENTION

### Technical Problem

Therefore, the present invention has been made in view of the above and/or other problems, and it is an object of the present invention to effectively distribute the resources of a mobile communication terminal in order to display various contents in the mobile communication terminal.

It is another object of the present invention to endow functions to a mobile communication terminal so that it is possible to easily search various contents screens in the mobile communication terminal.

The objects of the present invention are not limited to the above-described objects but other objects that are not described will be apparently understood by those skilled in the art from the following description.

### Technical Solution

In accordance with the present invention, the above and other aspects can be accomplished by the provision of a mobile communication terminal that is capable of multi-displaying contents information that is composed of independent channels, the mobile communication terminal comprises an input unit for a user inputting commands in order to read or check contents information, a communication unit for transmitting contents information on channels to a service server and for receiving the contents information on channels from the service server through a communication network, a display unit for displaying the contents information that is provided from the service server or the contents information that is stored in the mobile communication terminal on a window screen, a storage unit for storing the contents information and contents information screen forming programs that enable the contents information to be composed of independent channels, and a control unit for updating the previously stored contents information to corresponding recent contents information, for forming a requested screen in accordance with the input of a user, and for assigning resources so that the plurality of contents information items are multi-displayed on one display screen.

The contents information is preferably real time contents information.

A plurality of contents information items preferably overlap to be displayed in the multi-display and the overlap preferably has a minimum value.

The level values of the plurality of contents information items that overlap to be displayed are preferably set in accordance with the order where the contents information items are displayed on a display screen and, when the level value is 0, the contents information is preferably displayed on the uppermost part of the display screen.

The level value is preferably selected by a user.

The display unit preferably further comprises a window state display unit for checking the state of a currently displayed window.

The window screen corresponding to the contents information is preferably scrolled.

The size of the window screen corresponding to the contents information is preferably increased or reduced.

The window screen corresponding to the contents information is preferably panned.

There is provided a method of multi-displaying contents information that is composed of independent channels on a mobile communication terminal, the method comprising the steps of (a) a user selecting a window screen corresponding to contents information to be displayed, (b) setting the level of the window screen corresponding to the contents information, (c) determining whether there is a window screen that coincides with the window screen that is previously displayed on a mobile communication terminal, (d) creating a window screen corresponding to the contents information when it is determined that there is no window screen that coincides with the window screen that is previously displayed on the mobile communication terminal, and (e) assigning resources to the window screen that is created by the input of a user to multi-display a plurality of contents information items on one display screen.

The step (b) preferably further comprises the steps of (b-1) the mobile communication terminal requesting the level of a window screen to be changed, (b-2) the mobile communication terminal changing the level setting parameter of the window screen, and (b-3) the mobile communication terminal changing the window screen level.

The step (c) preferably further comprises the steps of (c-1) the mobile communication terminal checking the coordinates of a previously displayed window screen, (c-2) searching the window screen having the uppermost level in accordance with the result of the step (c-1), (c-3) checking the window screen having the uppermost level and the level of a new window screen, and (c-4) determining the coordinate values of the new window screen in accordance with the result of the step (c-3).

The step (d) preferably further comprises the steps of (d-1) a user selecting a window screen to be activated, (d-2) comparing the coordinate values of the activated window that is selected by the user with an input focus value, (d-3) determining whether the window that is selected by the user is a currently activated window, and (d-4) assigning resources for operating the window that is selected by the user as the activated window.

The step (d) preferably further comprises the steps of (d-1) receiving information on channels in which contents information is to be stored from a service server, (d-12) analyzing the information on channels that is received from the service server to determine whether channels to be received exist, (d-13) when it is determined in the step (d-12) that the channels to be received exist, receiving the channels from the service server to form the channels and receiving contents information from the service server to the formed channels, and (d-14) regulating the contents information by each channel that is received from the service server to display the contents information on a screen.

After the step (d-13), it is preferable to further comprise the steps of (d-21) determining whether channels to be received from the service server further exist and (d-22) terminating connection to the server when it is determined in the step (d-21) that no channels to be received exist.

In the step (d-13), when idle channels exist, an agent for managing the idle channels is preferably created so that the contents information is received from the service server to the idle channels using the created agent.

There is provided a computer readable recording medium in which programs for executing a method of multi-displaying contents information that is composed of independent channels on a mobile communication terminal by a computer, the method comprising the steps of (a) a user selecting a new window screen so that the new window is displayed on a mobile communication terminal, (b) setting the level of the new window screen, (c) the mobile communication terminal determining whether a window screen exists, (d) creating a new window screen in accordance with the result of the step (c), and (e) assigning resources to the window screen that is created in accordance with the input of the user to multi-display a plurality of contents information items on one display screen.

### Advantageous Effects

According to the present invention, an agent is created for a mobile communication terminal to independently control channels and the resources of the mobile communication terminal are distributed so that channels that use independent network paths are effectively used by the created agent.

Also, according to the present invention, a panning effect or a scroll function is provided in the mobile communication terminal so that various contents screens are easily searched.

### BRIEF DESCRIPTION OF THE DRAWINGS

FIG. 1 illustrates a mobile communication terminal screen that is implemented according to an embodiment of an idle screen template of “Method and Apparatus for Controlling and Managing Idle Screen Resources for Mobile Communication Terminal” of International Patent Application No. PCT/KR2004/000897;

FIG. 2 is a block diagram illustrating a mobile communication terminal that displays independent channel information according to the present invention;

FIG. 3 is a flowchart illustrating a method of, when a new window is created in the mobile communication terminal according to the present invention, checking the level and coordinates of the window to intellectually form a screen;

FIG. 4 is a flowchart illustrating a method of assigning resources in accordance with the activation of a window in the mobile communication terminal according to the present invention;

FIG. 5 is a flowchart illustrating a method of the mobile communication terminal according to the present invention displaying independent channel information in connection with a service server;

FIG. 6 is a flowchart illustrating a method of the mobile communication terminal according to the present invention creating the independent channel information in connection with the service server; and

FIG. 7 illustrates the screen of a mobile communication terminal according to an embodiment of the present invention in which channels are independently provided to form a screen so that the screen can be scrolled.

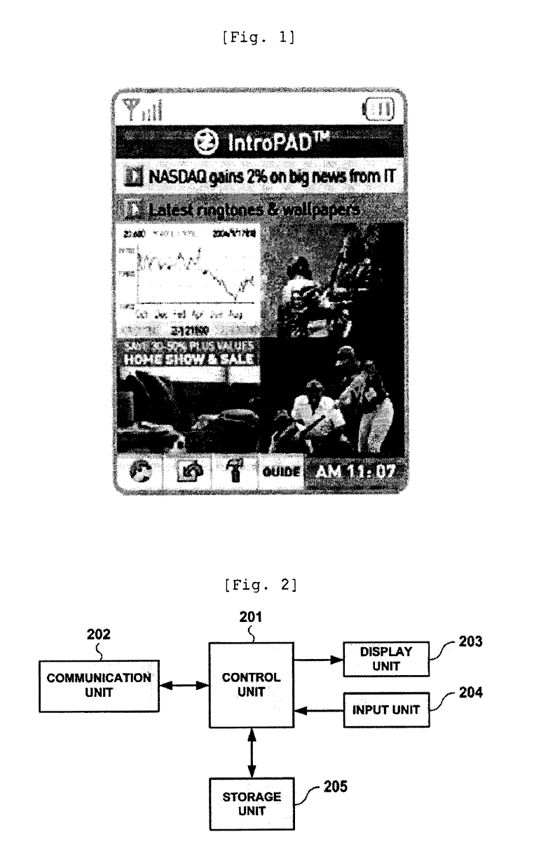

### BEST MODE FOR CARRYING OUT THE INVENTION

FIG. 2 is a block diagram illustrating a mobile communication terminal that displays independent channel information according to the present invention.

As illustrated in FIG. 2, the mobile communication terminal that displays the independent channel information according to the present invention comprises a control unit 201, a communication unit 202, a display unit 203, an input unit 204, and a storage unit 205.

The control unit 201 updates previously stored contents information to corresponding recent contents information, forms a requested screen in accordance with the input of a user, and assigns resources so that a plurality of contents information items are multi-displayed on one display unit 203.

The contents information is changed in real time to be updated.

That is, the control unit 201 controls the mobile communication terminal to update information in real time and to display independent channels, controls a command in accordance with the input of a user and the access and release of a service server, and forms the screen that is requested by the command of the user so that the screen is displayed or that the real time information is temporarily stored in a buffer.

The communication unit 202 transmits information on the channels to the service server and receives information on the channels from the service server through a communication network.

The display unit 203 visualizes the received real time information and update information so that the user can see the visualized real time information and update information to display the visualized real time information and update information. The display unit 203 displays the contents information that is provided from the service server or the contents information that is stored in the mobile communication terminal on a window screen.

That is, a plurality of window screens are formed of various contents information items so that the window screens are simultaneously displayed on the display unit 203 and a window state display unit or means by which it is possible to check the state of the window that is currently displayed is provided to improve the readability of the user.

The input unit 204 provides a key button, a pointing device, or icon type input means for the user to input a command, to update the real time information, and to scroll or pan a plurality of contents windows in order to read or check the contents information.

The storage unit 205 compares previous information with new information to determine whether the previous information is to be updated and stores programs and information for updating the real time information.

That is, it is determined whether new information exists from the server corresponding to the information that is previously stored in the storage unit and updates the previously stored information to the new information when it is determined that the new information exists to store the updated information in the storage unit so that the stored information is multi-displayed through the display unit 203 of the mobile communication terminal.

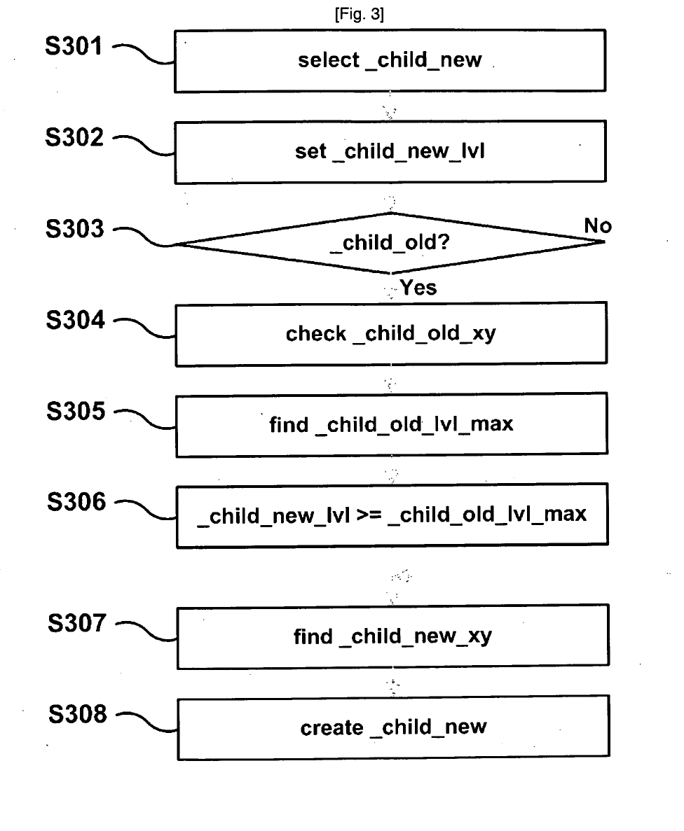

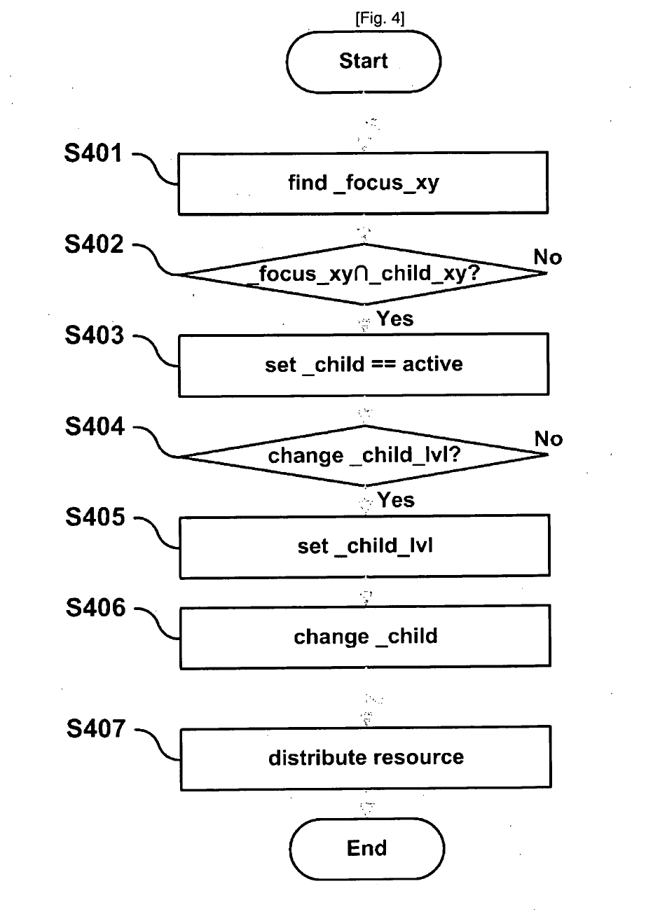

FIG. 3 is a flowchart illustrating a method of, when a new window is created in the mobile communication terminal according to the present invention, checking the level and coordinates of the window to intellectually form a screen.

As illustrated in FIG. 3, according to the method of intellectually forming the screen in the mobile communication terminal, when a new window creation menu is selected (S301), the mobile communication terminal initializes the level of the new window (S302).

When the level of the new window is initialized, it is determined whether there are windows that are previously displayed on the screen in the mobile communication terminal (S303).

When it is determined that there are previously displayed windows, the coordinate values of the displayed windows are checked (S304).

The window having the lowermost level is searched among the windows whose coordinate values are checked (S305).

The value of the lowermost level is ‘0’, which is the value of the uppermost window screen.

the level of the window having the lowermost level among the previously displayed windows is compared with the level of the window to be newly created (S306).

The coordinate values of the new window are searched to intellectually form a screen based on the comparison result so that the previously displayed windows are not hided (S307).

The new window suitable for the coordinate values of the new window is displayed (S308).

When it is determined that there is no previously displayed window in the step (S303) of determining whether there are windows that are displayed on the screen in the mobile communication terminal, the step (S307) of searching the coordinate values of the new window based on the comparison result to intellectually form a screen so that the previously displayed windows are not hided is directly performed.

Therefore, it is possible to intellectually display a new window without hiding the windows that are previously displayed on the screen.

That is, it is possible to intellectually display various contents such as a short message service (SMS), a multimedia messaging system (MMS), a schedule management, a personal information management system (PIMS), and a clock or a world clock among various menus of the mobile communication terminal on a screen in the display unit of the mobile communication terminal.

A method of assigning resources in accordance with the activation of a window in the mobile communication terminal will be described in detail with reference to FIG. 4.

FIG. 4 is a flowchart illustrating the method of assigning resources in accordance with the activation of a window in the mobile communication terminal according to the present invention.

As illustrated in FIG. 4, in the method of assigning resources in accordance with the activation of a window in the mobile communication terminal, when a window screen to be activated is selected using the input device of the mobile communication terminal, the coordinate values of the input focus that is selected by the user are searched (S401).

The coordinate values of the input focus that is selected by the user are compared with the coordinate values of the window that is previously displayed on the screen (S402).

When the coordinate values of the input focus that is selected by the user are not in the range of the coordinate values of the window that is previously displayed on the screen, it is returned to a user input idle state. When the coordinate values of the input focus that is selected by the user are in the range of the coordinate values of the window that is previously displayed on the screen, the activation or deactivation parameter value of the screen is set as activation among the characteristic parameters of the window in the input focus of the user (S403).

A window level change is selected so that a window level may be changed again after changing the window corresponding to the input focus that is selected by the user to be activated (S404).

The set value of the level of the activated window that is in the range of the input focus that is selected by the user is changed (S405).

After the user changes the set value, the mobile communication terminal changes the window level (S406) and distributes resources to the activated window (S407).

The resources refer to various mobile communication terminal resources such as a communication network transmission bandwidth, a central processing unit share, and a storage unit.

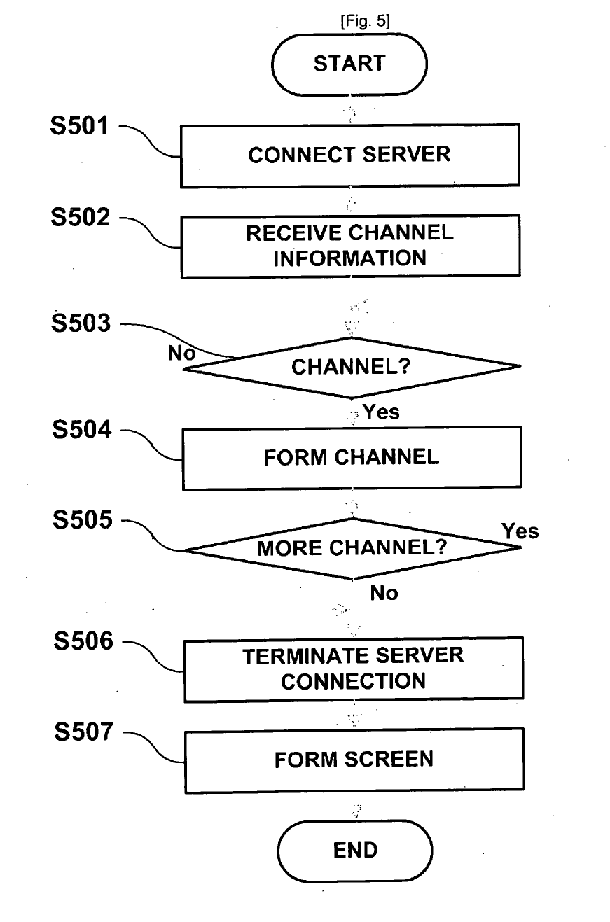

The is, the mobile communication terminal assigns resources to the window that is selected by the user and controls the level that is displayed on the screen so that the window is displayed in the uppermost end of the display unit of the mobile communication terminal or in the display unit to be suitable for the level that is selected by the user. A method of connecting the window that is selected by the user to the service server to assign channels and of receiving information on the channels will be described in detail with reference to FIG. 5.

FIG. 5 is a flowchart illustrating a method of the mobile communication terminal according to the present invention displaying independent channel information in connection with a service server.

As illustrated in FIG. 5, according to the method of the mobile communication terminal displaying the independent channel information, the mobile communication terminal is connected to the service server to receive information on the channel to be connected such as the structure of the channel and the kind of the channel (S501).

After the mobile communication terminal is connected to the service server, the mobile communication terminal receives the information on the channel from the service server (S502).

The mobile communication terminal analyzes the information on the channel that is received from the service server to determine whether there exists a channel to be received (S503).

When it is determined that the channel information to be received from the service server exists, the mobile communication terminal forms a channel to be received to receive channel information from the formed channel (S504).

When the channel information is completely extracted from the current channel, the mobile communication terminal determines whether a channel to be received from the service server further exists (S505).

When it is determined that there is no channel information to be received, the mobile communication terminal terminates connection to the service server (S506).

The mobile communication terminal regulates the information on the channels that is received from the service server to display the information on a screen (S507).

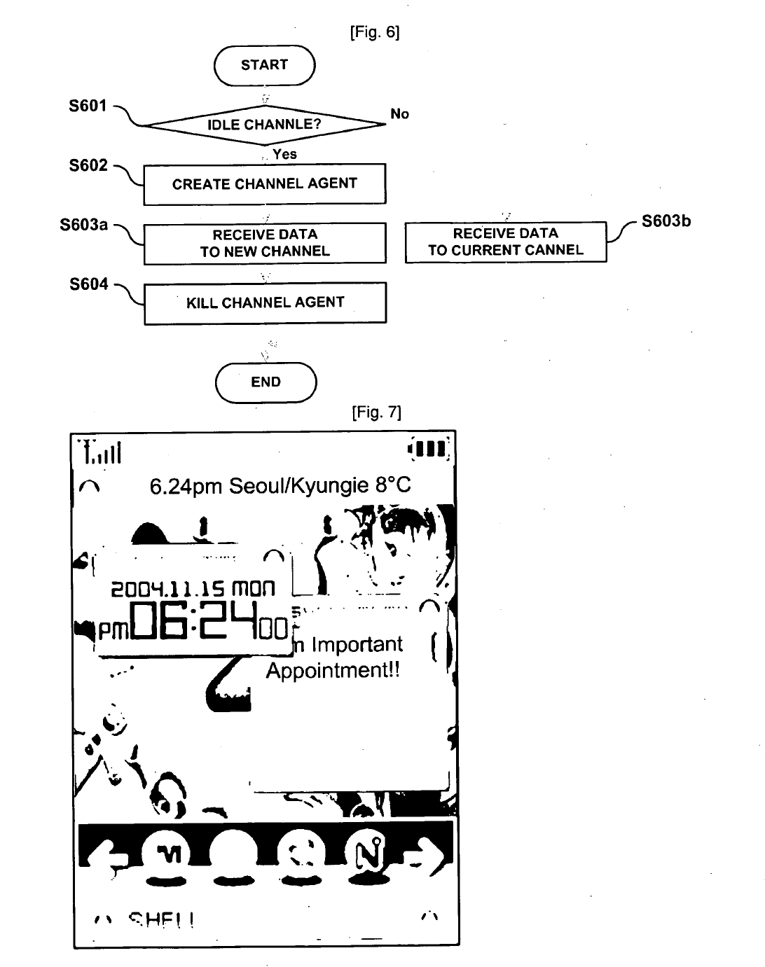

A method of the mobile communication terminal connecting the window that is displayed on the display unit to the service server to receive the channel information, displaying the channel information on the display unit of the mobile communication terminal, assigning resources, receiving data to a new channel in accordance with the assignment of resources, and creating and killing an agent for receiving the data to the new channel will be described in detail with reference to FIG. 6.

FIG. 6 is a flowchart illustrating a method of the mobile communication terminal according to the present invention creating independent channel information in connection with the service server.

As illustrated in FIG. 6, according to the method of the mobile communication terminal creating the independent channel information, the mobile communication terminal determines whether idle channels exist (S601).

When it is determined that the idle channels exist, an agent for managing the idle channels is created by the mobile communication terminal (S602).

The contents information that is transmitted from the service server to the channels is received using the agent that is created by the mobile communication terminal as an actor (S603a).

When the contents information is received, the mobile communication terminal kills the agent for the channels (S604).

When it is determined that no idle channels exist, the mobile communication terminal receives the contents information from the service server using previously connected channels (S603b).

That is, the mobile communication terminal may receive the contents information from the previously connected channels. However, when the idle channels exist, the agent for managing the idle channels is created by the mobile communication terminal to independently receive the contents information from the service server using the idle channels.

When a large number of idle channels exist, a reception performance is improved and various contents information items are continuously received.

The life cycle of the agent that is created by the mobile communication terminal is determined by the creation and killing of the contents information items that are transmitted to the channels.

Various contents are displayed on the display unit of the mobile communication terminal, the displayed contents are connected to the service server to form channels, and information on the channels is received to intellectually display windows on the display unit of the mobile communication terminal.

An embodiment that is implemented by the method according to the present invention is illustrated in FIG. 7.

FIG. 7 illustrates the screen of a mobile communication terminal according to an embodiment of the present invention in which channels are independently provided to form a screen so that the screen can be scrolled.

As illustrated in FIG. 7, the contents information items that are received from a plurality of channels are positioned in the mobile communication terminal in various methods and the mobile communication terminal searches and scrolls various contents windows through a virtual screen.

A scroll is formed in each displayed window so that it is possible to scroll a window having a large screen.

In the mobile communication terminal, the channels for audio and data communications are in various states such as active, control/hold, suspended, and dormant modes. In all of the modes excluding the dormant mode, the channels are occupied in the mobile communication terminal so that the channels are in the states such as use and control/idle.

The idle channels are checked in the dormant mode among the modes and the idle channels are activated or occupied so that various contents information items are received from the service server to improve the utility of the mobile communication terminal.

A scroll function is provided so that a virtual screen or a virtual region is formed in order to provide various contents information items in the mobile communication terminal having a relatively small screen to implement panning effect and to search the virtual screen.

Although not shown, a function of increasing or reducing the size of the screen may be added to easily check a plurality of contents.

1. A mobile communication terminal that is capable of multi-displaying contents information that is composed of independent channels, the mobile communication terminal comprising:
an input unit for a user inputting commands in order to read or check contents information;
a communication unit for transmitting contents information on channels to a service server and for receiving the contents information on channels from the service server through a communication network;
a display unit for displaying the contents information that is provided from the service server or the contents information that is stored in the mobile communication terminal on a window screen;
a storage unit for storing the contents information and contents information screen forming programs that enable the contents information to be composed of independent channels; and
a control unit for updating the previously stored contents information to corresponding recent contents information, for forming a requested screen in accordance with the input of a user, and for assigning resources so that the plurality of contents information items are multi-displayed on one display screen.

2. The mobile communication terminal as claimed in claim 1, wherein the contents information is real time contents information.

3. The mobile communication terminal as claimed in claim 1,
wherein a plurality of contents information items overlap to be displayed in the multi-display, and
wherein the overlap has a minimum value.

4. The mobile communication terminal as claimed in claim 3,
wherein the level values of the plurality of contents information items that overlap to be displayed are set in accordance with the order where the contents information items are displayed on a display screen, and
wherein, when the level value is 0, the contents information is displayed on the uppermost part of the display screen.

5. The mobile communication terminal as claimed in claim 4, wherein the level value can be selected by a user.

6. The mobile communication terminal as claimed in claim 1, wherein the display unit further comprises a window state display unit for checking the state of a currently displayed window.

7. The mobile communication terminal as claimed in claim 1, wherein the window screen corresponding to the contents information can be scrolled.

8. The mobile communication terminal as claimed in claim 1, wherein the size of the window screen corresponding to the contents information can be increased or reduced.

9. The mobile communication terminal as claimed in claim 1, wherein the window screen corresponding to the contents information can be panned.

10. A method of multi-displaying contents information that is composed of independent channels on a mobile communication terminal, the method comprising the steps of:
(a) a user selecting a window screen corresponding to contents information to be displayed;
(b) setting the level of the window screen corresponding to the contents information;
(c) determining whether there is a window screen that coincides with the window screen that is previously displayed on a mobile communication terminal;
(d) creating a window screen corresponding to the contents information when it is determined that there is no window screen that coincides with the window screen that is previously displayed on the mobile communication terminal; and
(e) assigning resources to the window screen that is created by the input of a user to multi-display a plurality of contents information items on one display screen.

11. The method as claimed in claim 10, wherein the step (b) further comprises the steps of:
(b-1) the mobile communication terminal requesting the level of a window screen to be changed;
(b-2) the mobile communication terminal changing the level setting parameter of the window screen; and
(b-3) the mobile communication terminal changing the window screen level.

12. The method as claimed in claim 10, wherein the step (c) further comprises the steps of:
(c-1) the mobile communication terminal checking the coordinates of a previously displayed window screen;
(c-2) searching the window screen having the uppermost level in accordance with the result of the step (c-1);
(c-3) checking the window screen having the uppermost level and the level of a new window screen; and
(c-4) determining the coordinate values of the new window screen in accordance with the result of the step (c-3).

13. The method as claimed in claim 10, wherein the step (d) further comprises the steps of:
(d-1) a user selecting a window screen to be activated;
(d-2) comparing the coordinate values of the activated window that is selected by the user with an input focus value;
(d-3) determining whether the window that is selected by the user is a currently activated window; and
(d-4) assigning resources for operating the window that is selected by the user as the activated window.

14. The method as claimed in claim 10, wherein the step (d) further comprises the steps of:
(d-11) receiving information on channels in which contents information is to be stored from a service server;
(d-12) analyzing the information on channels that is received from the service server to determine whether channels to be received exist;
(d-13) when it is determined in the step (d-12) that the channels to be received exist, receiving the channels from the service server to form the channels and receiving contents information from the service server to the formed channels; and
(d-14) regulating the contents information by each channel that is received from the service server to display the contents information on a screen.

15. The method as claimed in claim 14, wherein, after the step (d-13) further comprising the steps of:
(d-21) determining whether channels to be received from the service server further exist; and
(d-22) terminating connection to the server when it is determined in the step (d-21) that no channels to be received exist.

16. The method as claimed in claim 14, wherein, in the step (d-13), when idle channels exist, an agent for managing the idle channels is created so that the contents information is received from the service server to the idle channels using the created agent.

17. A computer readable recording medium in which programs for executing a method of multi-displaying contents information that is composed of independent channels on a mobile communication terminal by a computer, the method comprising the steps of:
(a) a user selecting a new window screen so that the new window is displayed on a mobile communication terminal;
(b) setting the level of the new window screen;
(c) the mobile communication terminal determining whether a window screen exists;
(d) creating a new window screen in accordance with the result of the step (c); and
(e) assigning resources to the window screen that is created in accordance with the input of the user to multi-display a plurality of contents information items on one display screen.
